(19) United States
(12) Patent Application Publication
(10) Pub. No.: US 2007/0263137 A1
(43) Pub. Date: Nov. 15, 2007

(54) Illuminating device and display device

(75) Inventors: Masanobu Shigeta, Kanagawa-ken (JP); Shingo Yagyu, Kanagawa-ken (JP); Tetsuhiro Yamazaki, Kanagawa-ken (JP)

Correspondence Address: NATH & ASSOCIATES, PLLC;Six Floor, 1030 15th Street, N.W., Washington, DC, 20005, US

(73) Assignee: VICTOR COMPANY OF JAPAN, LIMITED, Yokohama-shi (JP)

(21) Appl. No.: 11/797,814

(22) Filed: May 8, 2007

(30) Foreign Application Priority Data
May 9, 2006 (JP) P2006-130864
Jun. 12, 2006 (JP) P2006-162319

(51) Int. Cl. G02F 1/1335

(52) U.S. Cl. 349/63

(57) ABSTRACT

To provide a illuminating device that is of small size, light weight and that has lower production costs for illuminating a reflective type liquid crystal display device that performs high contrast, moreover high definition and high-quality image display, thereby enabling realization of an image display that is of small size and light weight and that can be produced at low-cost. The display device comprises a light source 5 disposed in a lateral position in relation to the image display surface 3 of the reflective type liquid crystal display device 2, that emits linearly polarized light, and a plurality of reflecting members 6 disposed to the front of the image display surface 3 and separated from the image display surface 3, that reflect light emitted from the light source 5 and inject this light substantially perpendicularly in relation to the image display surface 3. The plurality of reflecting members 6 are arranged to the front of part of the region of the image display surface 3 of the reflective type liquid crystal display device 2 and at least part of the light injected into the image display surface 3 that is reflected by the image display surface 3 is emitted toward the forward side of the image display surface 3.

### TECHNICAL FIELD

The present invention relates to a illuminating device for illuminating a reflective type liquid crystal display device, and a display device such as a projector, an electronic viewfinder (EVF) or a head mount display (HMD), incorporating this illuminating device and reflective liquid crystal display device.

### BACKGROUND ART

A variety of different display devices for displaying images have been disclosed in the conventional art and in recent times the desire has been towards an increase in the size of the display image display surface of display devices. The demand for these larger type image display surfaces has been especially strong for displays viewed by the public in outside, areas (public view), for displays used for administrative and management work and for display devices that provide high precision images such as high vision and the like. Projection type display devices (projectors) have also been proposed as display devices for image display on a large image display surface.

Projection type display devices that have been proposed in the conventional art include for example, transparent type devices using a liquid crystal display device as well as reflective type devices that employ a reflective type liquid crystal display device such as those disclosed in Japanese Patent Application Laid-Open No. 2000-193994 and Japanese Patent Application Laid-Open No 2003-185972. Both of these types of display device however are constructed using liquid crystal display devices, illuminate the liquid crystal display device using an illuminating light, modulate this illuminating light via the liquid crystal display, pixel by pixel, in coordination with an image signal, and form an image from this illuminating light that passes via the liquid crystal device so as to obtain a displayed image.

FIG. 1 provides a side view showing the configuration of a conventional display device that utilizes a reflective type liquid crystal display.

As shown in FIG. 1 this conventional display device that utilizes a reflective type liquid crystal display has a light source 101 that generates a light L. The light L emitted from the light source 101 is reflected at the reflective surface of a polarized light beam splitter 102 and injected into a reflective type liquid crystal display device 103. The liquid crystal display device 103 is constructed having liquid crystals enclosed therein, such that the L injected into the liquid crystal display device 103 is polarized and modulated in coordination with an image signal and reflected. The light L (modulated light) thus modulated and reflected by the liquid crystal display device 103 returns to the polarized light beam splitter 102 passing the reflective face thereof and enters a projection lens 104. The projection lens 104 displays an image on a image display surface 105 by projecting the L (modulated light) to form an image on that image display surface.

The liquid crystal display device 103 is constructed having liquid crystals LC sealed in between a drive substrate 106 and a transparent opposing electrode 107. A plurality of reflective type pixel electrodes (reflective electrodes) 108 are formed in a matrix configuration on the surface of the drive substrate 106. In the liquid crystal display device 103 each of these pixel electrodes 108 are arranged separated by a determined pixel width and arranged longitudinally in a matrix formation, such that the plurality of the pixels forms a matrix in the longitudinal direction.

FIG. 2 is an equivalent circuit diagram showing a pixel of a liquid crystal device.

As shown in the equivalent circuit diagram of FIG. 2, the single pixel of the liquid crystal display device 103 has for example a switching transistor Tr comprising a moss transistor, holding capacity C connected to the drain D of a switching transistor Tr, while the drain D is also connected to a pixel electrode 108. Further, in the switching transistor Tr the source S is connected to a signal wire 109 that delivers an image signal, and a gate G is connected to a gate wire 110.

In this liquid crystal display device 103, with an image signal being provided in the signal wire 109, the gate G is turned on by the gate wire 110 and as this pixel is periodically selected, the image signal is accumulated in the holding capacity C. When the gate G goes to off, the charge stored in the holding capacity C is supplied to the pixel electrode 108 for a determined time interval, making the liquid crystals LC of this pixel operate.

FIG. 3 is an expanded cross-sectional drawing showing the configuration of the major parts of the liquid crystal display device.

As shown in FIG. 3, the liquid crystal display device 4 is comprised having a drive substrate 106, opposing electrode 107 and liquid crystals LC sealed between these. The drive substrate 106 has a semi conductor substrate 111 comprised for example of a P type silicon substrate, while a switching transistor Tr comprised of a source S, drain D and a gate G is formed on the surface. A holding capacity C is formed connected to this transistor Tr. The drive circuit that drives the pixel electrode 108 is comprised of this transistor Tr and holding capacity C.

The plurality of pixel electrodes 108 arranged in matrix formation on the upper layer part of the drive substrate 106 are in a condition insulated from each other by a small gap 112 formed between each adjacent pixel electrode 108. Each gap 112 is the same width as a pixel.

Between the pixel electrode and the semiconductor substrate 111 a light shield layer 114 which combines with wiring is disposed with the insulating layer 113 of for example SiO₂ interposed between the pixel electrode and the light shield layer 114. The light shield layer 114 blocks as much light as possible that enters via the gap 112 toward the semiconductor substrate 111 side, and is formed for example of aluminum or an aluminum alloy.

Further, between the light shield layer 114 and the semiconductor substrate 111 a wiring layer 116 is interposed via an insulating layer 115 formed for example of SiO₂. The wiring layer 116 is a dispersed body, part of this layer acting as a signal wire by being connected to the source S of the switching transistor Tr, another part being connected to both the drain D and holding capacity C while also being connected via the light shield layer 114 to the pixel electrode. An oriented film 117 is formed above the pixel electrode.

The opposing electrode 107 is formed under a transparent substrate 118 comprised of for example a transparent glass sheet, while an oriented film 119 is formed under this opposing electrode 107. The liquid crystals LC are enclosed between the drive substrate 106 and the transparent substrate 118 abutting the opposing electrode 107 via a spacer not shown in the drawing, thereby forming the liquid crystal display device 103.

This kind of reflective type liquid crystal display device 103 enables a drive circuit comprised of a switching transistor Tr and holding capacity C to be formed under (the rear side) of the pixel electrode, thereby realizing a substantial opening ratio in comparison to a transparent type liquid crystal display. The opening ratio means the ratio occupied by the pixel region involved with light modulation in relation to the total display area. A decrease in the size of the pixels makes this effect proportionately more conspicuous.

Accordingly, the reflective type liquid crystal display device 103 is able to realize a higher resolution of image display on a smaller area in contrast to what can be achieved by a transparent type liquid crystal display.

This kind of reflective type liquid crystal display 103 can display images with extremely high precision when used with a projector type image display (projector) or head mount display (HMD).

As disclosed in Japanese Patent No. 3394460 and Japanese Patent Application Laid-Open No. 11-202799 these reflective type liquid crystal display devices are also used in mobile telephones in what are called direct type display devices. In these types of display device an illuminating device providing a light source (front light system) is used to provide supplementary light when visibility is difficult relying on external light only.

These illuminating devices introduce light from a light source via a wave guide plate, reflect and polarize the illuminating light in the direction of a liquid crystal display device by a reflective part that is for example, a V-shaped groove or dot form for example, and provide illumination for the liquid crystal display device.

These types of display devices however are designed to display information such as letters or drawings and are configured such that the liquid crystal display device can be observed directly by the naked eye without the need of an image forming optical system. Further, in these types of display devices the contrast ratio for a displayed image is 10:1 small for actual viewing while the size of pixels of the liquid crystal display device being used is from approximately 200μ or 300μ to 1 mm. Thus such devices cannot achieve the high-definition image display envisaged by the present invention and are unable to display high contrast, high quality images.

The reflective type liquid crystal display device used for a display device (projector or HMD) as described above is what is known as a microdevice with extremely small pixel size of approximately 10 micrometers. Further, this kind of liquid crystal display device is able to be used for cinematic viewing for example, and provides a contrast ratio for displayed images that is extremely high, in the region of 200-300:1 to 2000-3000:1 during actual use

In the optical system of the above described display device both the light incident to the liquid crystal display device and the reflected light travel the same optical path, thus the optical paths must be separated by a polarized light beam splitter. The polarized light beam splitter has a reflective surface inclined at an angle of 45°, and, being formed as a solid cuboid shape it occupies a substantial mass between the liquid crystal display device and projection lens and it is heavy.

For this reason there are significant problems associated with providing a display device of this kind that is of compact size and light weight. Further, because it is necessary to make the distance between the liquid crystal display device and the projection lens exactly match the size of the polarized light beam splitter, there is another problem associated with the high cost required for the projection lens. Moreover, the polarized light beam splitter itself is an expensive optical component having a substantial impact on raising the cost of the display device.

Again, with display devices having a configuration in which an image is magnified by a loupe, such as a head mount display (HMD) or electronic viewfinder (EVF), that is to say, image display devices having a configuration wherein image display is performed when a virtual image is formed using a focusing lens, incorporating a polarized light beam splitter mitigates against downsizing the dimensions of the device and contributes to higher costs.

Note that, while illuminating devices (front light systems) that employ a wave guide plate have been proposed, as described above, if such a device is incorporated in a display device applied for a liquid crystal display device that uses extremely small pixels, the reflective part of the wave guide plate is obstructive, and normal image display can not be realized.

Further, in such illuminating devices, the light is reflected repeatedly inside the wave guide plate such that the condition of polarization of the light changes completely, preventing realization of an image display device configuration that can display images having a high contrast ratio.

With the foregoing in view, it is an object of the present invention to provide a illuminating device that realizes a small size device construction that is light weight, and which can be produced at a low production cost, which illuminating device is used for illuminating a reflective type liquid crystal display device that realizes display of high contrast, high definition, high quality images.

Further, by providing the above described illuminating device, it is an object of the present invention, to provide a display device that in addition to being able to perform image display of high contrast, high precision, high quality images, is able to realize a small size device configuration that is light weight, and that can be produced at low cost

### SUMMERY OF THE INVENTION

In order to solve the above described problems and to realize the above objectives, the illuminating device related to the present invention may be of any of the following configurations.

### Configuration 1

The illuminating device related to the present invention is a illuminating device used for illumination of a reflective type liquid crystal display device, comprising a light source part that is arranged in a lateral position in relation to the image, display surface of the reflective type liquid crystal display device, that emits linear polarized light in a direction substantially parallel to the image display surface, a plurality of reflecting members, arranged in front of the image display surface of the reflective type liquid crystal display device and separated from the image display surface, that reflect the light emitted from the light source part and inject that light substantially vertically in relation to the image display surface, wherein the plurality of reflective members are arranged to the front of part of the region of the image display surface of the reflective type liquid crystal display device and at least part of the light injected into the image display surface that is reflected by the image display surface is emitted toward the forward side of the image display surface.

### Configuration 2

The illuminating device related to the present invention is the illuminating device according to the first configuration, wherein the plurality of reflecting members are arranged in front of not more than half of the region of the image display surface of the reflective type liquid crystal display device.

### Configuration 3

The illuminating device related to the present invention is the illuminating device according to the first configuration, wherein the plurality of reflective members are such that the ratio of the pitch of the reflective members to the width of that part which the reflected light from the reflective members cannot pass is not greater than 0.07.

### Configuration 4

The illuminating device related to the present invention is the illuminating device according to the first configuration, wherein the plurality of reflecting members are arranged inside a transparent, plane parallel plate arranged parallel to the image display surface and in front of the image display surface of this reflective type liquid crystal display device.

### Configuration 5

The illuminating device related to the present invention is the illuminating device according to the first configuration, wherein the plurality of reflecting members are the side wall faces of either groove parts or concave parts formed in the front part of a transparent, plane parallel plate arranged parallel to the image display surface and in front of the image display surface of the reflective type liquid crystal display device.

### Configuration 6

The illuminating device related to the present invention is the illuminating device according to the first configuration, wherein the plurality of reflecting members are arranged above the rear part of a transparent, plane parallel plate arranged parallel to the image display surface and in front of the image display surface of the reflective type liquid crystal display device

### Configuration 7

The illuminating device related to the present invention is the illuminating device according to the first configuration, wherein the plurality of reflecting members are the side wall faces of either convex parts or concave parts formed in the front part of a transparent, plane parallel plate arranged parallel to the image display surface and in front of the image display surface of the reflective type liquid crystal display device.

### Configuration 8

A illuminating device related to the present invention is the illuminating device according to the first configuration, wherein a light absorbing member is disposed in the part surrounding the reflecting member

### Configuration 9

The display device related to the present invention comprises the illuminating device according to the first configuration, a reflective type liquid crystal display device illuminated by that illuminating device, and an optical imaging system into which light reflected from the reflective type liquid crystal display device is injected, that forms either an actual or a virtual image of the image display surface of a reflective type liquid crystal display device, wherein the optical imaging system operates such that when the image display surface of the reflective type liquid crystal display device accommodates a determined focal depth, the plurality of reflecting members are outside that focal depth.

### Configuration 10

The illuminating device according to the present invention is a illuminating device that utilizes illumination of a reflective type liquid crystal display device, comprising a light source arranged in a lateral position in relation to the image display surface of a reflective type liquid crystal display device, that emits light that is substantially parallel to the image display surface, and hologram elements disposed in front of the image display surface of the reflective type liquid crystal display device and separated from the image display surface, that diffracts at least a part of the light emitted from the light source, and injects this diffracted light into the image display surface at an angle within a determined range centered around a direction perpendicular to the image display surface, wherein light is injected into the image display surface of the reflective type liquid crystal display device and modulated light modulated and reflected by this reflective type liquid crystal display device passes the hologram elements and is emitted to the frontal side of the image display surface.

The light that is not diffracted by the hologram elements is reflected according to the total reflection effect and does not reach the reflective type liquid crystal display device.

### Configuration 11

The illuminating device according to the present invention is a illuminating device according to the tenth configuration, wherein the hologram elements only diffract those light elements among the light emitted from the light source that are of a determined polarization, and do not exert any diffraction effect on incoming light of a polarization orthogonal to that determined polarization.

### Configuration 12

The illuminating device according to the present invention is the illuminating device according to the tenth configuration, wherein the hologram elements focus, or scatter and diffract light from the light source.

### Configuration 13

The display device according to the present invention comprises the illuminating device according to the tenth configuration, a reflective type liquid crystal display device illuminated by that illuminating device, and an optical imaging system into which modulated light reflected from the reflective type liquid crystal display device is injected, that forms either an actual or a virtual image of the image display surface of a reflective type liquid crystal display device, wherein the angle of light input from hologram elements to the image display surface of the reflective type liquid crystal display device which angle is within a determined range centered around a direction perpendicular to the image display surface, is the angle obtained as the light, after being reflected by the reflective type liquid crystal display device, is input to the optical imaging system.

In the case of the illuminating device related to the present invention of configuration 1, the plurality of reflective members are arranged to the front of part of the region of the image display surface of the reflective type liquid crystal display device, and at least part of the light input to this image display surface that is reflected by this image display surface is output toward the frontal side of that image display surface, thus by combining such reflective type liquid crystal display device with such an optical imaging system (optical expansion system), it is possible to provide a display device that can be of small size and light weight, and that can realize high contrast, high-definition moreover high brightness image display.

This display device can be comprised as a variety of different systems, such as a projection type display device (projector), a head mount display (HMD), or an electronic viewfinder (EVF) or the like.

Further, in the case of the illuminating device related to the present invention of configuration 2, the plurality of reflective members are arranged to the front of not more than half of the region of the image display surface of the reflective type liquid crystal display device, thus the light injected into this image display surface and off the reflective type liquid crystal display device and reflected at that image display surface, is satisfactorily emitted to the frontal direction of the image display surface, and by combining this configuration with an optical imaging system (optical expansion system), it is possible to provide a display device at low cost, that can be of small size and light weight, and that can realize high contrast, high-definition moreover high brightness image display.

In the case of the illuminating device related to the present invention of configuration 3, the plurality of reflective members are such that the ratio of the pitch of the reflective members to the width of that part which the reflected light from the reflective members cannot pass is not greater than 0.07, such that even in the case of high contrast ratio images it is possible to obtain clear image display with no ghosting effect.

In the case of the illuminating device related to the present invention of configuration 4, the plurality of reflective members are arranged inside a transparent, plane parallel plate arranged parallel to the image display surface and in front of the image display surface of the reflective type liquid crystal display device, thus it is possible to realize a small size and light weight configuration.

In the case of the illuminating device related to the present invention of configuration 5, the plurality of reflecting members are the side wall faces of either grooves or concave parts formed in the front part of a transparent, plane parallel plate arranged parallel to the image display surface and in front of the image display surface of the reflective type liquid crystal display device, thus it is possible to realize a small size and light weight configuration that can bc produced at low cost.

In the case of the illuminating device related to the present invention of configuration 6, the plurality of reflecting members are arranged above the rear part of a transparent, plane parallel plate arranged parallel to the image display surface and in front of the image display surface of the reflective type liquid crystal display device, thus it is possible to realize a small size and light weight configuration.

In the case of the illuminating device related to the present invention of configuration 7, the plurality of reflecting members are the side wall faces of either convex parts or concave parts formed in the front part of a transparent, plane parallel plate arranged parallel to the image display surface and in front of the image display surface of the reflective type liquid crystal display device, thus it is possible to realize a small size and light weight configuration that can be produced at little cost. Moreover, by employing this configuration 7 the optical path traveled by the light passes substantially through the air, and thus even when the transparent, plane parallel plate is formed using a material having somewhat large birefringence there is little deterioration in contrast ratio and illuminating irregularity, accordingly it is possible to employ a cheaper, plastic material.

In the case of the illuminating device related to the present invention of configuration 8, a light absorbing member is disposed in the part surrounding the reflecting member, thus the diffracted light in the part surrounding the reflective member can be absorbed, enabling realization of a configuration for a display device that can perform high contrast, high-definition moreover high brightness image display.

In the case of the display device related to the present invention of configuration 9, the above described illuminating device is provided, thereby enabling small size and light weight configuration having low production costs, and further, as the optical imaging system operates such that when the image display surface of the reflective type liquid crystal display device accommodates a determined focal depth, the plurality of reflecting members are outside that focal depth, there is no effect on the plurality of reflective members of the illuminating device, enabling realization of a device that can perform high contrast, high-definition moreover high brightness image display.

In the case of the illuminating device related to the present invention of configuration 10, hologram elements are disposed in front of the image display surface of the reflective type liquid crystal display device, and modulated light diffracted at these hologram elements, directed to the image display surface and then reflected at the image display surface, passes the hologram elements and his output to the frontal side of the image display surface. Thus by combining the reflective type liquid crystal display device and optical imaging system (optical expansion system), it is possible to provide a display device that can be of small size and light weight, and that can realize high contrast, high-definition moreover high brightness image display.

This display device can be comprised as a variety of different systems, such as a projection type display device (projector), a head mount display (HMD)), or an electronic viewfinder (EVF) or the like.

In the case of the illuminating device related to the present invention of configuration 11, the hologram elements only diffract those light elements among the light emitted from the light source that are of a determined polarization, and do not exert any diffraction effect on incoming light of a polarization orthogonal to that determined polarization, thus light directed to the image display surface of the reflective type liquid crystal display device, modulated and then reflected by this image display surface is satisfactorily emitted to the frontal direction of the image display surface, and by combining this configuration with an optical imaging system (optical expansion system), it is possible to provide a display device at low cost, that can be of small size and light weight, and that can realize high contrast, high-definition moreover high brightness image display

In the case of the illuminating device related to the present invention of configuration 12, the hologram elements focus light emitted from the light source, or, as the hologram elements have a light dispersing, light diffraction effect, the occurrence of illuminating irregularity on the image display surface of the reflective type liquid crystal display device is prevented, and it is possible to provide a display device at low cost, that can be of small size and light weight, and that can realize high contrast, high-definition moreover high brightness image display.

In the case of illuminating device related to the present invention of configuration 13, the above described illuminating device is provided, thereby enabling a small size, light weight device to be produced at low cost. Further, the angle of light input from hologram elements to the image display surface of the reflective type liquid crystal display device which angle is within a determined range centered around a direction perpendicular to the image display surface, is the angle obtained as the light, after being reflected by the reflective type liquid crystal display device, is input to the optical imaging system, therefore the light is used very efficiently, and high contrast, high-definition moreover high brightness image display can be performed.

That is to say, the present invention is a illuminating device that lights the image display surface of a reflective type liquid crystal display device that performs high contrast, high precision and high-quality image display, this invention providing a illuminating device that is of a small and light weight configuration, that moreover can be produced at little cost.

Further, the present invention provides the above described illuminating device and thus can perform high contrast, moreover high precision high quality image display, the invention providing a display device that is of a small and light weight configuration and that moreover can be produced at little cost

### BRIEF DESCRIPTION OF TUE DRAWINGS

FIG. 1 provides a side view showing the configuration of a conventional display device that utilizes a reflective type liquid crystal display;

FIG. 2 is an equivalent circuit diagram showing a pixel of a liquid crystal device;

FIG. 3 is an expanded cross-sectional drawing showing the configuration of the major parts of the liquid crystal display device;

FIG. 4 is a cross-sectional view showing the configuration of a display device providing the illuminating device according to the first embodiment of the present invention;

FIG. 5 shows a cross-sectional view of the configuration of the major parts of the illuminating device for the first embodiment related to the present invention;

FIG. 6 is a graph showing the relationship of the duty ratio of generic transmissive diffractive grating to optical intensity of 0 order light and first order diffracted light;

FIGS. 7A and 7B are graphs showing dimensions as they relate to the form of the V-shaped grooves as major parts of the first embodiment of the present invention and the duty ratio;

FIG. 8 is a cross sectional view showing another example of the configuration of the major parts of illumination device according to the first embodiment of the present invention;

FIG. 9 is a cross-sectional view showing another example of the configuration of the major parts of the illumination device according to the first embodiment of the present invention;

FIG. 10 is a cross-sectional view showing the configuration of a display device providing a illuminating device according to a second embodiment related to the present invention;

FIG. 11 is a cross-sectional view showing the configuration of the plane parallel plate comprising a major part of illuminating device according to the second embodiment related to the present invention;

FIG. 12 is a cross sectional view showing the configuration of the major parts of the illuminating device according to the second embodiment related to the present invention;

FIG. 13 is a cross sectional view showing an example of the configuration of the major parts of illumination device according to the second embodiment of the present invention;

FIG. 14 is a cross sectional view showing the configuration of the display device providing the illuminating device according to the third embodiment related to the present invention;

FIG. 15 is a cross-sectional view showing the configuration of the major parts of the illuminating device according to the third embodiment related to the present invention;

FIGS. 16A, 16B, 16C and 16D show the steps requited for the production of the master hologram used in the illuminating device according to the third embodiment related to the present invention;

FIG. 17 is a cross-sectional view showing the condition in which exposure is performed by the interference of light exposure method utilizing a master hologram for producing the bologram elements of the illuminating device according to the third embodiment related to the present invention;

FIG. 18 is a graph showing the characteristics of the hologram elements of the illuminating device according to the third embodiment related to the present invention (for designed angle of incidence of 72°);

FIG. 19 is a graph showing the characteristics of the hologram elements of the illuminating device according to the third embodiment related present invention (for designed to angle of incidence of 60°);

FIG. 20 is a cross sectional view showing the configuration of the display device providing the illuminating device according to the fourth embodiment related to the present invention;

FIG. 21 is a cross-sectional view showing the configuration of a display device providing the illuminating device according to the fifth embodiment related to the present invention;

FIG. 22 is a cross sectional view showing the configuration of a display device relating to the present invention configured as a projection type display device (projector); and

FIG. 23 is a cross sectional view showing the configuration of a display device related to the present invention configured as an electronic viewfinder (EVF).

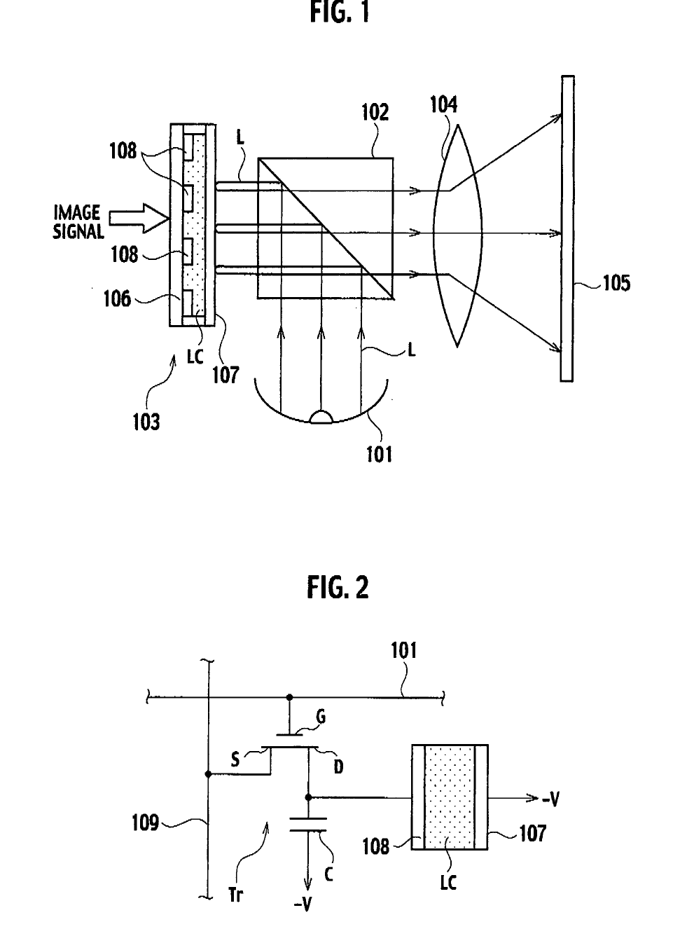

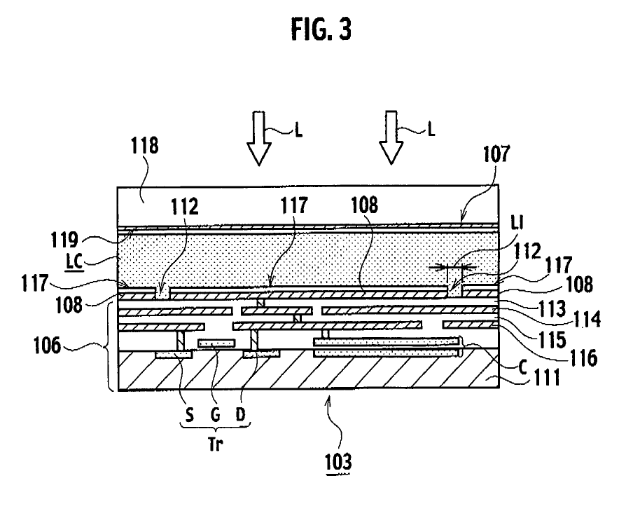

### DETAILED DESCRIPTION OF THE INVENTION

The best mode for carrying out the invention will now be described with reference to the drawings

### First Embodiment of the Illuminating Device According to the Present Invention

The illuminating device according to the present invention is a illuminating device employed in the display device related to the present invention described subsequently, that lights the display (liquid crystal layer) of a reflective type liquid crystal display device.

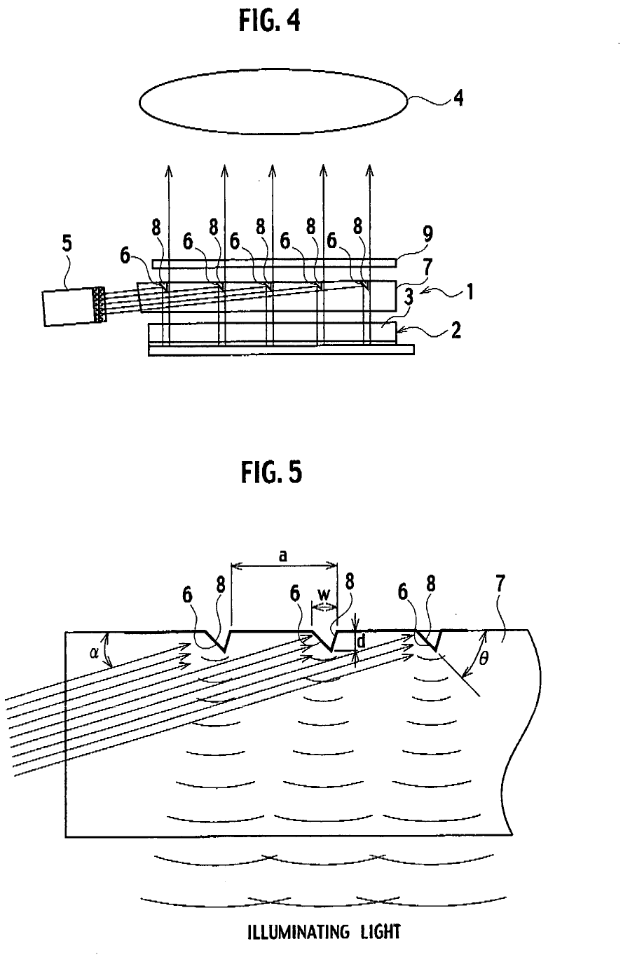

FIG. 4 is a cross-sectional view showing the configuration of a display device providing the illuminating device according to the first embodiment of the present invention.

As shown in FIG. 4, the display device according to the present invention comprises the illuminating device 1 relating to the present invention, a reflective type liquid crystal display device 2 that is illuminated by this illuminating device 1, and an optical imaging system 4 into which light reflected at the liquid crystal display device 2 is injected, that creates either an actual or a virtual image of the image display surface 3 of the liquid crystal display device 2.

This display device operates as a projection type display device (projector) when the optical imaging system 4 forms an actual image of the image display surface 3 of the liquid crystal display device 2 on a image display surface not shown in the drawing, while when the optical imaging system 4 forms a virtual image of the image display surface 3 of the liquid crystal display device 2 this display device operates as a bead mount display (HMD) or an electronic viewfinder (EVF).

The liquid crystal display device 2 is the same as that utilized in the conventional display device described previously comprised having liquid crystals enclosed between a drive substrate and an opposing electrode. A plurality of reflective type pixel electrodes (reflecting electrodes) are formed in a matrix configuration on the surface of the drive substrate. In this reflective type liquid crystal display device each pixel electrode is separated by a precise, determined pixel interval, and is arranged in a matrix configuration in the longitudinal and horizontal directions, thus the plurality of pixels are arranged in a matrix configuration in the longitudinal and horizontal directions.

This illuminating device 1 of the display device performs illuminating of the image display surface 3 of the liquid crystal display device 2, the illuminating device 1 has a light source 5 arranged in a lateral position to the image display surface 3 of the liquid crystal display device 2. The light source 5 emits parallel light rays of linear polarization to the image display surface 3.

The light source 5 may be provided in the form of a light source that is a laser diode or a light emitting diode (LED: Light Emitting Diode).

If the light source is provided in the form of a laser diode the light emitted from the light source is of linear polarization If the light source is provided in the form of an LED, the light emitted from the light source passes a polarizing filter or the like and becomes light of linear polarization.

In the illuminating device 1, light emitted from the light source 5 is reflected and there are a plurality of reflecting members 6 that inject this light substantially vertically in relation to the image display surface 3 of the liquid crystal display device 2. These reflecting members 6 are arranged to the front of the image display surface 3 of the liquid crystal display device 2 and separate from the image display surface 3, moreover, the reflecting members 6 are arranged to the front of a region of a part, that comprises a very small proportion of the area in relation to the entirety of the image display surface 3 of the liquid crystal display device 2. Light reflected by the reflecting members 6 is not injected in a direction that is perfectly perpendicular in relation to the image display surface 3, but light reflected from the liquid crystal display device 2 passes between each of the reflecting members 6 so that it is injected having a slight, but determined angle (inclination). This slight, determined angle means that the light reflected at each of the reflecting members 6 maintains a direction of polarization, and moreover, must be of an angle (for injection into the optical imaging system 4) that enables compatibility with the optical imaging system 4 described subsequently.

In the case of this embodiment, as shown in FIG. 4, the plurality of the reflecting members 6 are arranged inside a transparent, plane parallel plate 7 that is disposed parallel to the image display surface 3 and to the front of the image display surface 3 of the liquid crystal display device 2. Moreover, the plurality of the reflecting members 6 can comprise the side wall faces of convex parts or groove parts 8 formed on the front surface part (the side having the optical imaging system 4) of the plane parallel plate 7.

The plane parallel plate 7 can be formed for example of glass the refractive index n of which is 1.73. On the front part (the side having the optical imaging system 4) of the plane parallel plate 7 a plurality of V-shaped groove parts 8 the side wall faces of which comprise reflective members 6 are formed at determined intervals. The light source 5 is arranged so as to direct light towards these V-shaped grooves 8 and to pass inside the plane parallel plate 7, this being the optical beam configuration.

FIG. 5 shows a cross-sectional view of the configuration of the major parts of the illuminating device for the first embodiment related to the present invention.

As shown in FIG. 5, when for example the V-shaped grooves 8 have a pitch a of 50 μm, a depth d of 5 μm, with the angle θ of the side wall faces of the V-shaped grooves 8 comprising the reflecting members 6 being 42.1° in relation to the surface of the plane parallel plate 7, then by making the angle of incidence α of the incident light in relation to the surface of the plane parallel plate 7, 5.7°, the light can be made to reflect in the direction of the optical imaging system 4 at approaching 100% efficiency. That is to say, a parallel beam of light input from the light source 5 is reflected at the reflecting members 6 (the side wall faces of the V-shaped grooves 8) toward the liquid crystal display device 2. Here, light moving away from a single reflecting member 6 (side wall face of a V-shaped groove 8) undergoes total reflection as it moves to the next, adjacent reflecting member 6 (side wall face of the V-shaped groove 8), and in the same manner is directed toward the liquid crystal display device 2.

In this way, as shown in FIG. 4, light injected into the liquid crystal display device 2 is polarization-modulated in coordination to an image signal and reflected at the image display surface 3 (liquid crystal layer) of the liquid crystal display device 2. The plurality of the reflecting members 6 are disposed to the front of part of the region of the image display surface 3, that comprises a very small proportion of the area in relation to the entirety of the image display surface 3 of the liquid crystal display device 2. That is to say, as shown in FIG. 5, the proportion of the area occupied in relation to the area of the entirety of the image display surface 3 of the plurality of the reflecting members 6 is a proportion w/a in relation to the pitch a of the width w of the reflecting members 6. This proportion is sufficiently small. Accordingly, the greater part of the light entering the image display surface 3 and reflected by the image display surface 3 is not obstructed by the reflecting members 6 and is emitted to the frontal direction of the image display surface 3.

Note that a part of the light input to the plane parallel plate 7 reaches the frontal surface part of the plane parallel plate 7, regions where the V-shaped grooves 8 are not formed, and here a part of the light is reflected, while the remainder is considered as passing the frontal side. Further, part of the light that enters the edge parts of the V-shaped grooves 8 is emitted to the frontal side opposite the liquid crystal display device 2. Moreover, if there is any light that enters at an angle so as not to undergo total reflection at the side wall faces of the V-shaped grooves 8, this light can pass the side wall faces and be emitted to the frontal surface side of the plane parallel plate 7. Such light cannot be used as illuminating light and is unusable.

Such unusable light as well as light that is reflected while not being modulated at the liquid crystal display device 2 is absorbed by polarizing plate 9 disposed to the front of the plane parallel plate 7. The polarizing plate 9 is disposed so as only to pass light that is polarized in a direction orthogonal to light from the light source 5.

Light that is polarization modulated at the liquid crystal display device 2 and reflected and that passes the plane parallel plate 7 and the polarizing plate 9, enters the optical imaging system 4. As described above, the light entering the optical imaging system 4 forms either an actual or a virtual image for producing an image display.

When, in this illuminating device, light emitted from the light source 5 is not a perfect parallel beam, it enters as light beams having a spread, and as shown in FIG. 5, such light reflected at each of the reflecting members 6 is not a perfect parallel beam but has a spread angle equivalent to the spread angle at the time of incidence. Further, due to the diffraction effect the spread angle increases if there is nonuniformity in the form of the V-shaped grooves 8. Because each of the reflecting members 6 is removed sufficiently from the image display surface 3 in relation to the size of the pixels of the liquid crystal display device 2, each pixel comes to be illuminated by the light from the plurality of the reflecting members 6 thereby reducing the problem of illuminating irregularity. That is to say, the illuminating irregularity decreases as the spread angle of the light increases. In the case of this illuminating device, by making the width w of the reflecting members 6 not greater than 10 μm, utilizing the diffraction effect of the reflecting members 6 the resultant effect should be to decrease illuminating irregularity. Here, light entering each of the reflecting members 6 should maintain the same polarization direction after it is reflected at each of the reflecting members 6. However, it is necessary that the spread angle of the light maintains the same polarization direction after being reflected at each of the reflecting members 6 and moreover, that the angle of this light (the angle at which it enters the optical imaging system 4) is compatible with the optical imaging system 4.

If scattering is used in order to increase the spread angle of the light a deterioration in the contrast ratio of the displayed image results due to increased randomness in the polarization direction of the light. Accordingly, it is preferable to avoid the emergence of scattered light as much as possible. In this illuminating device the scattering effect is avoided and illuminating irregularity is reduced by providing a sufficient distance between each of the reflecting member's 6 and the image display surface 3 of the liquid crystal display device 2.

Further, when the light entering the liquid crystal display device 2, modulated at the liquid crystal layer and reflected travels toward the optical imaging system 4, if each of the reflecting members 6 operate to obstruct passage of the light black lines will develop projected layered over the displayed image, resulting in a deterioration in the quality of the displayed image.

In this display device, when the optical imaging system 4 keeps the image display surface 3 of the liquid crystal display device 2 within the focus depth the plurality of the reflecting members 6 are removed from the focus depth. That is to say, the image display surface 3 and each of the reflecting members 6 are separated by a sufficient distance. For example, in the case of this embodiment, the gap between the image display surface 3 and each of the reflecting members 6 is approximately 5 mm The focus surface of the optical imaging system 4 matches that of the image display surface 3 of the liquid crystal display device 2 and as each of the reflecting members 6 (V-shaped grooves 8) is outside the focus depth, the image on each of the reflecting members 6 (dark lines) is formed sufficiently blurred. That is to say, the image on each of the reflecting members 6 is not dark lines but is formed such that the darkness appears uniform over the entirety of the displayed image, thereby preventing a deterioration in the quality of the displayed image.

The decrease in the brightness of the displayed image from the image of each of the reflecting members 6 is proportionate to the width w (area) of each of the reflecting members 6. Accordingly, it is preferable that the pitch a of the reflecting members 6 (the V-shaped grooves 8), the width w and the setting of the distance of the reflecting members 6) from the image display surface 3 be determined with consideration of the balance of the light emitting efficiency of the light source 5 and the illuminating irregularity (how readily visible the black lines are) in coordination with the objective for which the display device is to be used. Here, it follows naturally that the black lines become less visible to the extent that the width w of the reflecting members 6 narrows, but if the width w is not greater than 1 μm the spread angle of the light becomes excessively large due to diffraction and it becomes difficult to inject all of the light into the optical imaging system 4. Accordingly, the width w of the reflecting members 6 should preferably be between 1 μm and 10 μm. Further, the plurality of reflecting members 6 should be disposed to the front of not more than one half of the region of the image display surface 3 of the liquid crystal display device 2, that is to say, the total image projected area of the plurality of the reflecting members 6 should preferably be not more than one half of the area of the image display surface 3.

The ghosting effect (double or multiple layered images) will now be described

The illuminating device 1 related to the first embodiment of the present invention is disposed at a determined distance from a liquid crystal display device 2.

With this arrangement, the reflective member 6 acts as an obstruction that prevents reflected light from passing an image formed by the liquid crystal display device 2, and if each reflective member 6 is disposed at a determined interval there are cases when the ghosting effect can be observed due to the effect of the resulting diffractive grating. Especially in the case of contrast ratio imaging systems that are employed for home theaters and the like, this can lead to a deterioration in the quality of the displayed images.

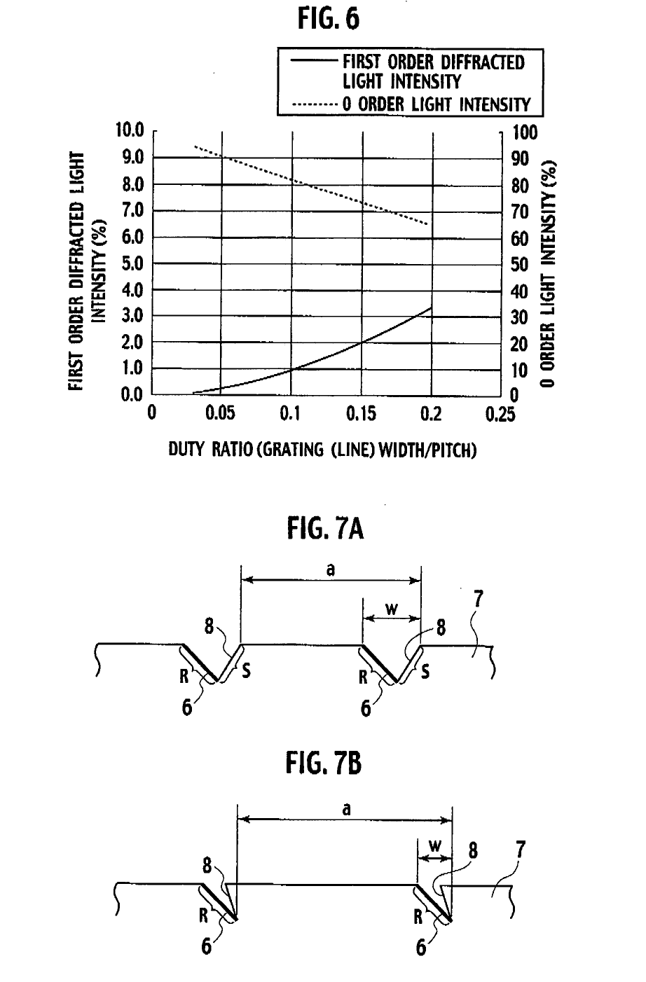

FIG. 6 is a graph showing the results obtained by calculating the relationship of duty ratio (ratio of pitch and grating (line) width), to 0 order optical intensity and first order diffracted light optical intensity.

In contrast to 0 order light that is light used in image display, the first order diffracted light is the main cause of the ghosting effect. The result of the assessment of the images obtained indicate that no practical problem exists where the ratio DR of first order diffracted light to 0 order light is not greater than 0.5%. Accordingly, as evidenced by the graph shown in FIG. 6, a value not greater than 0.07 is suitable as the duty ratio when the above ratio DR is not greater than 0.5%.

Here, in the case of the V-shaped groove part 8 of the form shown in FIG. 7A, the width w of that part being the reflective surface R of the reflective member 6 and that part being the inclined surface S of the opposing side thereto is the width of the grid of the diffractive grating (that is to say, the width of the part which reflected light cannot pass).

Moreover, in the case of the V-shaped groove part 8 of the form shown in FIG. 7B, the width w of that part being the reflective surface R of the reflective member 6 is the width of the grid of the diffractive grating (that is to say, the width of the part which reflected light cannot pass).

Again, the pitch a of the reflective member 6 need not be at constant intervals, and it is sufficient to consider this pitch in terms of an average value where variations exist.

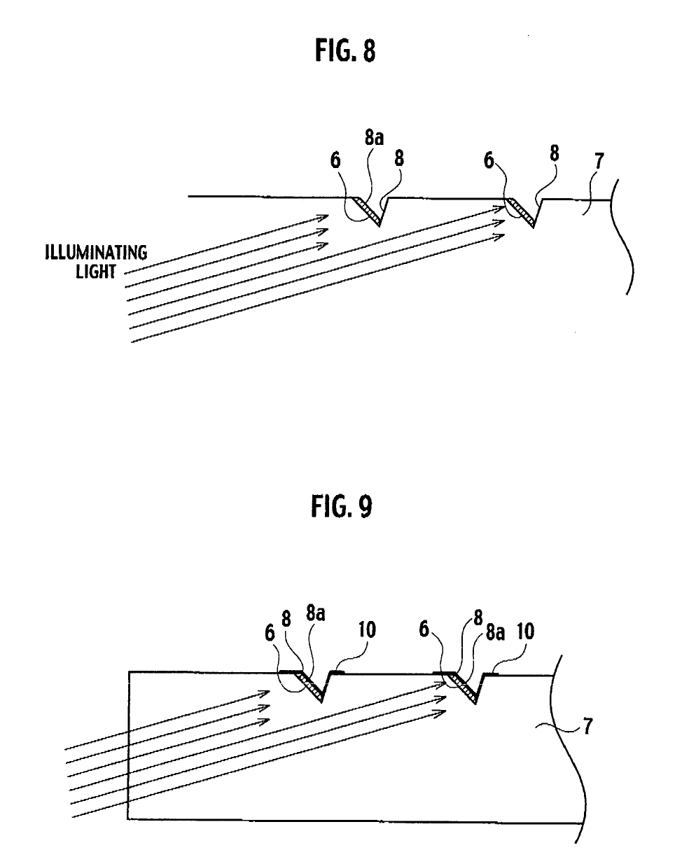

FIG. 8 is a cross sectional view showing another example of the configuration of the major parts of illumination device according to the first embodiment of the present invention.

The material for the plane parallel plate 7 should preferably be highly refractive material in order to reduce the angle of total reflection. For example, if the plane parallel plate 7 is formed from materials such as silica glass having a low refractive index total reflection will not occur at the reflecting members 6 (side walls of the V-shaped grooves 8) due to the angle of incidence of the light.

In this case, as shown in FIG. 8, it is preferable to form a reflective film 8a from a metal having a high reflectance such as an aluminum alloy or silver alloy or the like inside the V-shaped grooves 8 following along the side walls. The total reflection effect may become random due to changes in the properties of the surface of a member or due to foreign substances becoming adhered to a member. Accordingly, even when a material having a high refractive index is used a greater degree of reliability is attained through a configuration in which the reflective film 8a is formed.

FIG. 9 is a cross-sectional view showing another example of the configuration of the major parts of the illumination device according to the first embodiment of the present invention.

As shown in FIG. 9, it is preferable that a light absorbing material (black stripe) 10 be provided in the area surrounding the reflecting members 6. Providing this light absorbing material 10 means that scattered light that emerges easily in the edge parts around the reflecting members 6 can be definitively cut out. The width of the light absorbing material 10 should preferably be somewhat broader than the width of the reflecting members 6 (V-shaped groove 8). If the width of the light absorbing material 10 is made broader than the width of the reflecting members 6 it is possible to definitively suppress the emergence of the little scattered light that emerges around the edges of the reflecting members 6.

Note that the reflecting members 6 may be comprised not of the side wall parts of a V-shaped groove 8 as described above, but by embedding a reflective plate such as a metal alloy plate or the like inside the plane parallel plate 7.

### Second Embodiment of the Illuminating Device According to the Present Invention

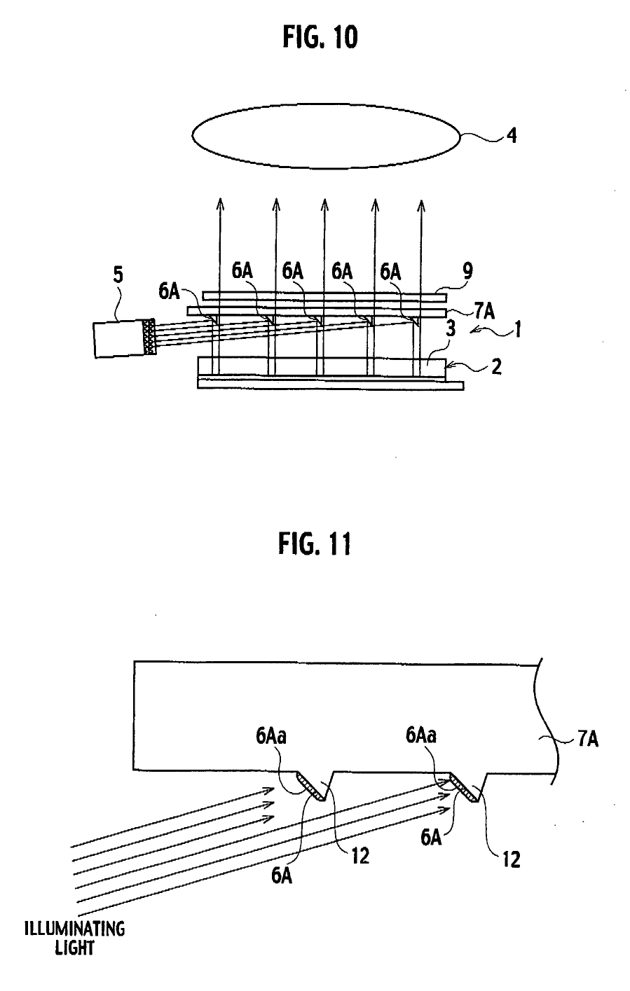

FIG. 10 is a cross-sectional view showing the configuration of a display device providing a illuminating device according to a second embodiment related to the present invention.

Note that in the following description of the display device that provides a illuminating device according to the second embodiment, like reference numerals identify elements that are the same as those comprising the display device having a illuminating device according to the first embodiment.

In this illuminating device related to the present invention, as shown in FIG. 10, the plurality of reflecting members 6A can be disposed over the rear surface part (that side where the liquid crystal display device 2 resides) of a transparent, plane parallel plate 7a disposed to the front of the image display surface 3 of the liquid crystal display device 2 and parallel to this image display surface 3.

FIG. 11 is a cross-sectional view showing the configuration of the plane parallel plate comprising a major part of illuminating device according to the second embodiment related to the present invention.

Here, as shown in FIG. 11, the plurality of the reflecting members 6A can be comprised in the form of the side wall faces of either convex parts 12 or concave parts formed in the rear surface of a plane parallel plate 7a. The respective side wall faces on the side of these convex parts 12 on which the light source 5 is, have a reflective film 6Aa comprised of a thin aluminum film or the like. In this case, the plurality of the reflecting members 6A reflect the light emitted from the light source 5 and inject this light in a direction perpendicular to the image display surface 3 of the liquid crystal display device 2.

The plane parallel plate 7a is formed for example of a transparent plastic or the like. A plurality of the convex parts 12 the side wall faces of which comprise the reflecting members 6A are formed at determined intervals on the rear surface part (that side on which the liquid crystal display device 2 is disposed) of this plane parallel plate 7a. The light source 5 is disposed so as to direct light having an optimum beam formation to the convex part 12 from the rear surface part of the plane parallel plate 7A.

These reflective members 6A are disposed to the front of the image display surface 3 of the liquid crystal display device 2 and removed from the image display surface 3. Moreover, the reflecting members 6A are disposed to the front of part of the region of the image display surface 3 of the liquid crystal display device 2.

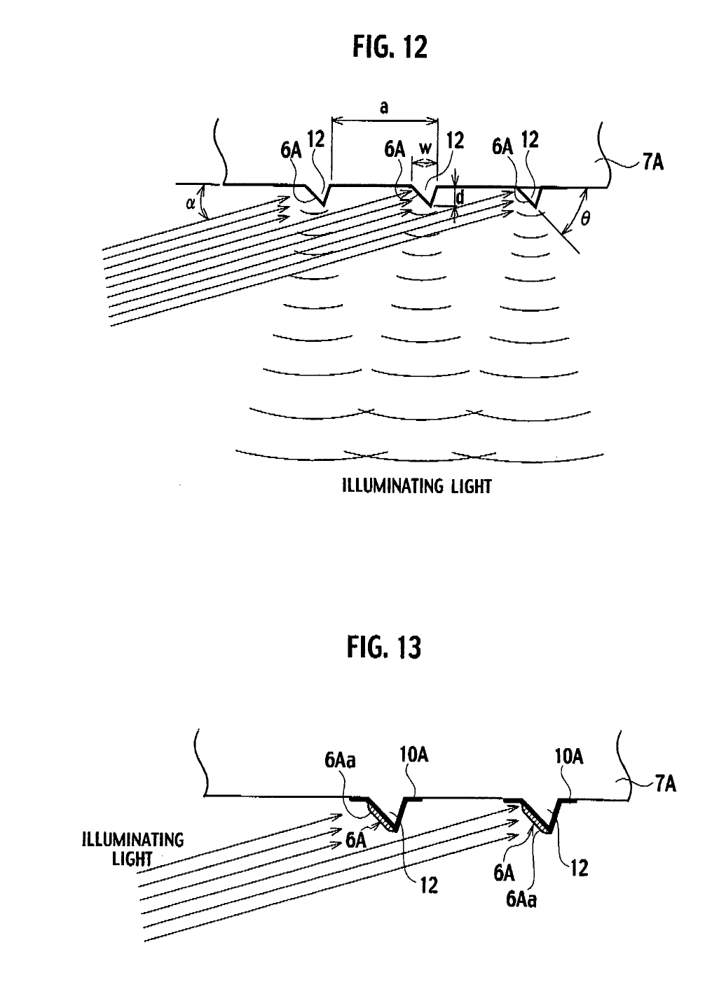

FIG. 12 is a cross sectional view showing the configuration of the major parts of the illuminating device according to the second embodiment related to the present invention.

As shown in FIG. 12, when for example the convex parts 12 have a pitch a of 50 μm, a depth d of 5 μm, with the angle θ of the side wall faces of the convex part 12 comprising the reflecting members 6A being 42.1° in relation to the surface of the plane parallel plate 7A, then by making the angle of incidence α of the incident light in relation to the surface of the plane parallel plate 7A 5.7°, the light can be made to reflect in the direction of the optical imaging system 4 at approaching 100% efficiency. That is to say, a parallel beam of light input from the light source 5 is reflected at the reflecting members 6A (the side wall face of the convex part 12) toward the liquid crystal display device 2. Here, light moving away from a single reflecting member 6A (side wall face of the convex part 12) undergoes reflection as it moves to the next, adjacent reflecting member 6A (side wall face of the convex part 12), and in the same manner is directed toward the liquid crystal display device 2.

In this way, as shown in FIG. 10, light injected into the liquid crystal display device 2 is polarization-modulated in coordination to an image signal and reflected at the image display surface 3 (liquid crystal layer) of the liquid crystal display device 2. The plurality of the reflecting members 6A are disposed to the front of a region of the image display surface 3 thus at least a part of the light injected to the image display surface 3 that is reflected at the image display surface 3 is not obstructed at the reflecting members 6A and is emitted to the frontal direction of the image display surface 3.

Note that a part of the light input to the plane parallel plate 7A reaches the frontal surface part of the plane parallel plate 7A, regions where the convex part 12 are not formed, and here a part of the light is reflected, while the remainder is considered as passing the plane parallel plate 7A and being emitted into the atmosphere from the surface on the opposing side at an angle that is the same as the angle of incidence. Further, part of the light that enters the edge parts of the convex part 12 is emitted to the frontal side opposite the liquid crystal display device 2. Such light cannot be used as illuminating light and is unusable

Such unusable light as well as light that is not modulated at the liquid crystal display device 2 is absorbed by polarizing plate 9 disposed to the front of the plane parallel plate 7A. The polarizing plate 9 is disposed so as only to pass light that is polarized in a direction orthogonal to light from the light source 5.

Light that is polarization modulated at the liquid crystal display device 2 and reflected and that passes the plane parallel plate 7A and the polarizing plate 9, enters the optical imaging system 4. As described above, the light entering the optical imaging system 4 forms either an actual or a virtual image for producing an image display.

When, in this illuminating device, light reflected at each of the reflecting members 6A is not a perfect parallel beam, as shown in FIG. 12, it enters as a light beam having a spread equivalent to the spread angle at the time of incidence. Further, due to the diffraction effect the spread angle increases if there is nonuniformity in the form of the convex part 12. Because each of the reflecting members 6A is removed sufficiently from the image display surface 3 in relation to the size of the pixels of the liquid crystal display device 2, each pixel comes to be illuminated by the light from the plurality of the reflecting members 6A thereby reducing the problem of illuminating irregularity. That is to say, the illuminating irregularity decreases as the spread angle of the light increases. In the case of this illuminating device, by making the width w of the reflecting members 6A not greater than 10 μm, utilizing the diffraction effect of the reflecting members 6 the resultant effect should be to decrease illuminating irregularity. Here, light entering each of the reflecting members 6A should maintain the same polarization direction after it is reflected at each of the reflecting members 6A.

If scattering is used in order to increase the spread angle of the light a deterioration in the contrast ratio of the displayed image results due to increased randomness in the direction of polarization of the light. Accordingly, it is preferable to avoid the emergence of scattered light as much as possible. In this illuminating device the scattering effect is not used and illuminating irregularity is reduced by providing a sufficient distance between each of the reflecting members 6A and the image display surface 3 of the liquid crystal display device 2.

Further, when light entering the liquid crystal display device 2, modulated at the liquid crystal layer and reflected travels toward the optical imaging system 4, if each of the reflecting members 6A operate to obstruct passage of the light black lines will develop projected layered over the displayed image, resulting in a deterioration in the quality of the displayed image.

In this illuminating device, when the optical imaging system 4 keeps the image display surface 3 of the liquid crystal display device 2 within the focus depth the plurality of the reflecting members 6A are outside the focus depth. That is to say, the image display surface 3 and each of the reflecting members 6A are separated by a sufficient distance. For example, in the case of this embodiment, the gap between the image display surface 3 and each of the reflecting members 6A is approximately 5 mm. The focus surface of the optical imaging system 4 matches that of the image display surface 3 of the liquid crystal display device 2 and as each of the reflecting members 6A (the convex part 12) is outside the focus depth, the image on each of the reflecting members 6A (dark lines) is formed sufficiently blurred. That is to say, the image on each of the reflecting members 6A is not dark lines but is formed such that the darkness appears uniform over the entirety of the displayed image, thereby preventing a deterioration in the quality of the displayed image.

The decrease in the brightness of the displayed image from the image of each of the reflecting members 6A is proportionate to the width w (area) of each of the reflecting members 6A. Accordingly, it is preferable that the pitch a of the reflecting members 6A (the convex part 12), the width w and the setting of the distance of the reflecting members 6A) from the image display surface 3 be determined with consideration of the balance of the light emitting efficiency of the light source 5 and the illuminating irregularity (how readily visible the black lines are) in coordination with the objective for which the display device is to be used. Here, it follows naturally that the black lines become less visible to the extent that the width w of the reflecting members 6A narrows, but if the width w is not greater than 1 μm the spread angle of the light becomes excessively large due to diffraction and it becomes difficult to inject all of the light into the optical imaging system 4. Accordingly, the width w of the reflecting members 6A should preferably be between 1 μm and 10 μm. Further, the plurality of reflecting members 6A should be disposed to the front of not more than one half of the region of the image display surface 3 of the liquid crystal display device 2, that is to say, the total image projected area of the plurality of the reflecting members 6A should preferably be not more than one half of the area of the image display surface 3.

FIG. 13 is a cross sectional view showing an example of the configuration of the major parts of illumination device according to the second embodiment of the present invention.

As shown in FIG. 13, it is preferable that a light absorbing material (black stripe) 10A be provided in the area surrounding the reflecting members 6A. Providing this light absorbing material 10A means that scattered light that emerges easily in the edge parts around the reflecting members 6A can be definitively cut out. The width of the light absorbing material 10A should preferably be somewhat broader than the width of the members 6A (the convex part 12). If the width of the light absorbing material 10A is made broader than the width of the reflecting members 6A it is possible to definitively suppress the emergence of the little scattered light that emerges around the edges of the reflecting members 6A.

Note that the reflecting members 6A may be comprised not of the side wall parts of a convex part 12 as described above, but by joining a reflective plate such as a metal alloy plate or the like over the rear surface part of the plane parallel plate 7A.

### Third Embodiment of the Illuminating Device According to the Present Invention

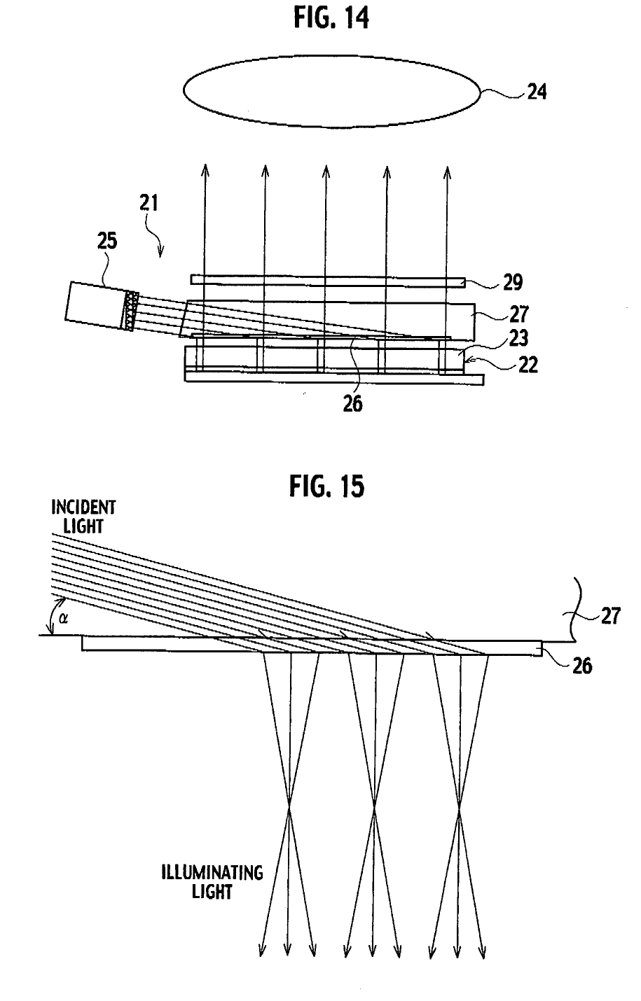

FIG. 14 is a cross sectional view showing the configuration of the display device providing the illuminating device according to the third embodiment related to the present invention.

As shown in FIG. 14, this display device related to the present invention comprises a illuminating device 21 related to the present invention, a reflective type liquid crystal display device 22 that is lighted by the illuminating device 21, and an optical imaging system 24 into which modulated light reflected at this reflective type in liquid crystal display device 22 is input, that creates either an actual or a virtual image on the image display surface 23 of the reflective type liquid crystal display device 22.

This display device operates as a projection type display device (projector) when the optical imaging system 24 forms an actual image of the image display surface 23 of the reflective type liquid crystal display device 22 on a image display surface not shown in the drawing, and operates as a head mount display (HMD) or an electronic viewfinder (EVF) when the optical imaging system 24 forms a virtual image of the image display surface 23 of the reflective type liquid crystal display device 22.

The reflective type liquid crystal display device 22 is the same as those used in display devices of the conventional technology as described above, and is configured having liquid crystals enclosed between a drive substrate and a transparent opposing electrode.

A plurality of reflective type pixel electrodes (reflecting electrodes) are formed in a matrix configuration on the surface of the drive substrate. In this reflective type liquid crystal display device 22 each of the pixel electrodes is separated exactly by a determined pixel interval and is arranged forming a matrix configuration in the longitudinal and horizontal directions, such that the arrangement of the plurality of pixels forms a matrix configuration in the longitudinal and horizontal directions.

The illuminating device 21 of this display device provides illuminating for the image display surface 23 of the reflective type liquid crystal display device 22. This illuminating device 21 is a light source 25 arranged in a lateral position with respect to the image display surface 23 of the reflective type liquid crystal display device 22. The light source 25 emits light substantially parallel to the image display surface 23. The light source 25 can be provided in the form of a laser diode or an LED or the like.

When a laser diode is used to provide this light source the light emitted from the light source is linear polarized light.

When an LED is used to provide the light source the light emitted from the light source can be made into linear polarized light by passing it through a polarizing filter or the like.

The illuminating device 21 has hologram elements 26 that diffract light emitted from the optical imaging system 24 and inject this light into the image display surface 23 of the reflective type liquid crystal display device 22, The hologram elements 26 are arranged to the front of the image display surface 23 of the reflective type liquid crystal display device 22 and removed from the image display surface 23, and are disposed extending over substantially the whole of the image display surface 23 of the reflective type liquid crystal display device 22.

In the case of this embodiment, as shown in FIG. 14 the hologram elements 26 are formed on the rear surface part of a transparent, plane parallel plate 27 disposed to the front of the image display surface 23 of the reflective type liquid crystal display device 22 and parallel to the image display surface 23. The plane parallel plate 27 can be formed for example of glass.

The light source 25 is arranged and configured including an optical system, so as to direct light having an optimum beam formation toward the hologram elements 26. The light from the light source 25 is injected in the side surface part of the plane parallel plate 27, passes inside the plane parallel plate 27 and irradiates toward the hologram elements 26 at a determined angle of incidence θ.

Substantially parallel light entering from the light source 25 is diffracted at the hologram elements 26 and injected to the image display surface 23 of the reflective type liquid crystal display device 22. The hologram elements 26 has a chirping structure, therefore the diffracted light converges and diverges within a determined angle and enters the image display surface 23. On the other hand, all of the light that is not diffracted at the hologram elements is reflected into the atmosphere and does not reach the reflective type liquid crystal display device 22.

Light input to the reflective type liquid crystal display device 22 is polarized and modulated in coordination with the image signal at the image display surface 23 (liquid crystal layer) of the reflective type liquid crystal display device 22 and reflected. The modulated light reflected in this way returns to the hologram elements 26. These hologram elements 26 diffract light of a determined polarization (S polarized light) input from the light source 25, with a high degree of efficiency, while light that is of a polarization that is orthogonal to the S polarized light (P polarized light) is basically not diffracted and is passed.

Accordingly, modulated light modulated and reflected at the reflective type liquid crystal display device 22 passes the hologram elements 26 and the plane parallel plate 27 in that condition, and passes a polarizing plate 29 disposed to the front side of the plane parallel plate 27. This polarizing page 29 is disposed so as only to pass polarized light the direction of polarization of which is a direction orthogonal to light emitted from the light source 25.

Modulated light that is polarization modulated at the reflective type liquid crystal display device 22 and reflected and that passes the hologram elements 26, the plane parallel plate 27 and the polarizing plate 29 enters the optical imaging system 24. As described above, modulated light entering the optical imaging system 24 forms either an actual or a virtual image for producing an image display.

Part of the light that is not modulated at the reflective type liquid crystal display device 22 may pass the plane parallel plate 27, however such light is cut at the polarizing plate 29 therefore there is no deterioration in the quality of the displayed image.

FIG. 15 is a cross-sectional view showing the configuration of the major parts of the illuminating device according to the third embodiment related to the present invention.

In the case of this illuminating device according to the third embodiment, as shown in FIG. 15, light diffracted at the hologram elements 26 as described above is not a perfect parallel beam but has a certain spread angle. The hologram elements 26 are separated from the image display surface 23 sufficiently in relation to the size of the pixels of the reflective type liquid crystal display device 22, thus each pixel is lighted by diffused light from the hologram elements 26 and there is an improvement in illuminating irregularity.

A method for producing hologram elements (hologram lens) 26 furnishing these lens effects will be described.

In the basic design of the hologram lens, the lens pattern can be obtained from the following basic formula (equation 1), that shows the relationship between the angle of outward travel (θ out) of diffracted light and the grating pitch (interference band intervals d).

θout=asin (mλ/nd−sin (θ in)) Equation 1

In this Equation 1, θ out is the angle of outward travel of diffracted light, m is the order of diffraction, λ is the wavelength of incident light n is the refractive index of the medium, d is the grating pitch and θ in shows the angle of incidence of incident light

In order that the angle of outward travel of diffracted light as determined by this Equation 1 be kept within a determined range, it is possible, by making the grating pitch variable (chirping), to provide characteristics to the hologram elements 26, such as the focus and diffusion and the like, that can be changed.

Further, with thick film hologram elements, known as a volume hologram, it is possible to obtain almost 100% diffraction efficiency by optimizing the refractive index differential Δ n of the interference band and the thickness To produce a volume hologram having the desired chirping structure it is necessary to produce a master hologram having the calculated pattern design. Then, a method for transcription to a hologram sensitive material such as a photo polymer can be used to employ this master hologram.

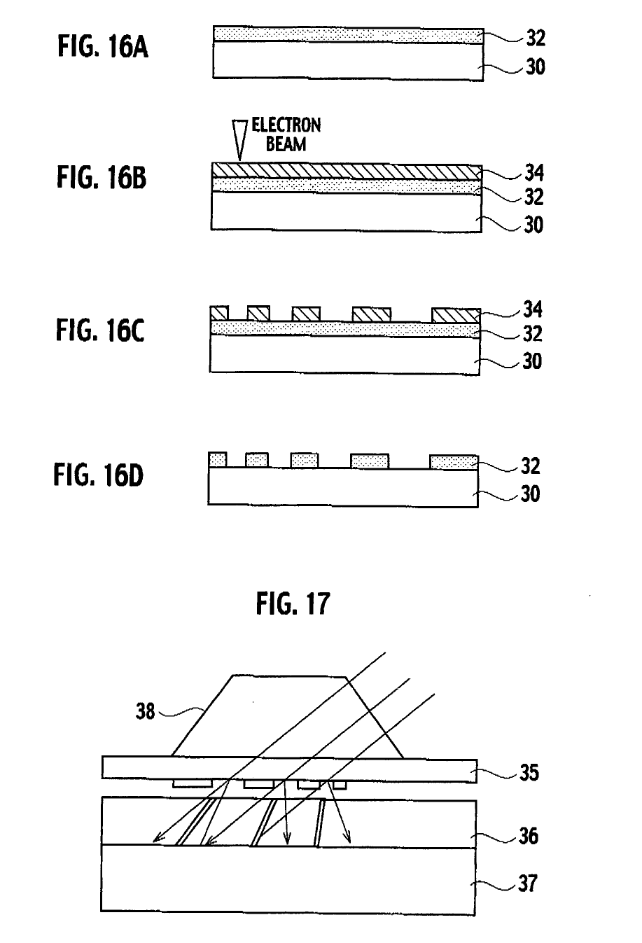

FIG. 16 shows the steps required for the production of the master hologram.

As shown in (a) in FIG. 16, the first step in producing the master hologram is to form a chrome (Cr) film 32 of a thickness of for example 1000 Å (approximately 100 nm) over a transparent substrate 30 comprised of quartz or glass or the like by using for example, a spattering or vapor deposition technique. It is preferable to form a chrome oxide layer on the surface of the chrome film 32 in order to prevent reflection. Besides a chrome film it is also possible to use any light blocking material to counteract light exposure.

Next, as shown in (b) in FIG. 16, a coating providing an electron beam exposure resist 34 is applied over the chrome film 32. Then, using an electron beam etching device a hologram lens array grating pattern is drawn over the resist 34. The data for this drawing operation is the grating pattern data that is calculated based on the Equation 1 described above using parameters set to achieve the desired focus characteristics.

Thereafter, as shown in (c) in FIG. 16, the resist 34 is developed in order to obtain the resist pattern. This resist pattern then provides the etching master for the etching of the chrome film 32. Using either a chlorine gas or an etching liquid either dry etching or wet etching is performed.

Then, as shown in (d) in FIG. 16 the remainder of the resist 34 is peeled off and removed to complete formation of a master hologram having a pattern of periodic slits formed of the parts of the chrome film 32 where the light has been blocked or has permeated.

FIG. 17 is a cross-sectional view showing the condition in which exposure is performed by the interference of light exposure method utilizing a master hologram.

As shown in FIG. 17, when producing the hologram elements 26 a film form hologram photo sensitive material 36 of a thickness of approximately 1 μm to 5 μm is adhered over a glass substrate 37 of a thickness for example of 5 mm approximately, that comprises a supporting body. Something like OmniDex a product name of a product from DuPont, can be used to provide this hologram photo sensitive material 36. It is also preferable to apply a PVA film over the hologram photosensitive material 36 to protect the surface of the photosensitive material

The master hologram 35 is then placed over the hologram photosensitive material 36, moreover, a light incidence prism 38 is then placed over the master hologram 35. Next, recording light is irradiated via the prism 38 and a fluid the refractive index of which matches that light, not shown in the drawing The light source for this recording light can be provided in the form of Ar lasers having for example an emission wavelength of 488 nm and an emission wavelength of 514.5 nm.

By irradiating this recording light, 0 order light that directly passes the master hologram lens 35 and first order diffracted light that is diffracted by the master hologram lens 35 interact, and interference bands are formed on the hologram photosensitive material 36. These interference bands are transferred to and recorded on the hologram photosensitive material 36. This is known as light interference exposure method.

Thereafter, a fixing process is performed using ultraviolet light exposure and, after increasing sensitivity to refractive index difference by performing a beating process applying heat at not less than 100 degrees Celsius, a volume hologram is obtained having high refractive index difference.

Besides the amplitude modulated hologram produced using electron beam etching as described above, this hologram used for the interference exposure method can also be provided by a volume hologram produced by transference from this kind of amplitude modulated hologram using the interference exposure method.

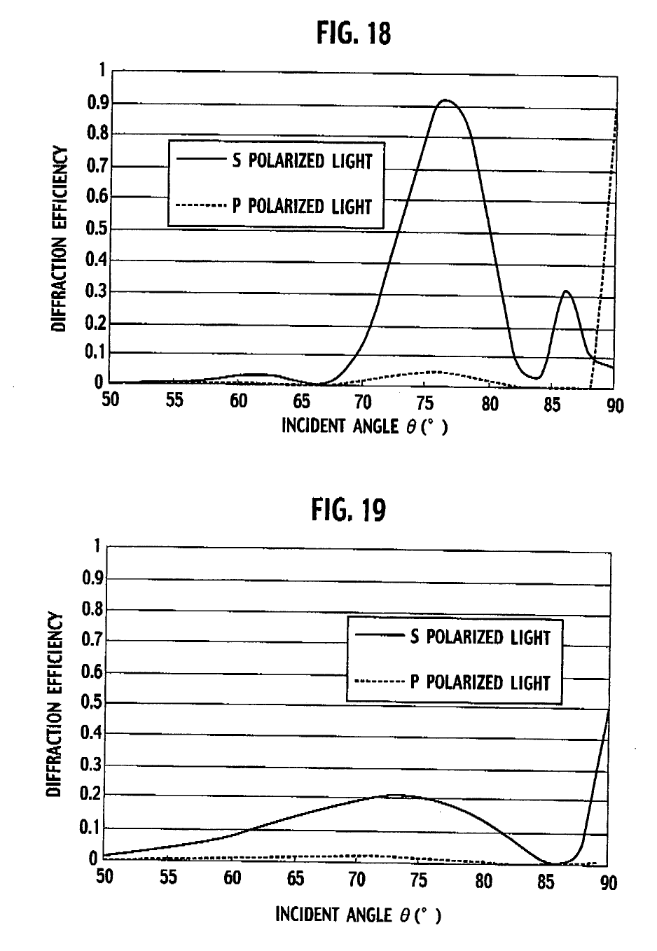

FIG. 18 is a graph showing the characteristics of a hologram elements (for designed angle of incidence of 72°).

Consider as an example of hologram elements 26 the case having a designed angle of incidence of 72 degrees, and being a photo polymer having a refractive index difference Δ n of 0.05. The film thickness is 2.4 μm. As shown in FIG. 18, the properties of such hologram elements 26 are that while the peak diffraction efficiency in relation to S polarized light is high the range of angles of incidence in which diffraction occurs is narrow, Accordingly, these hologram elements 26 are suitable to be used for generating light beams of a highly collimated angle as from a laser light source light source 25.

FIG. 19 is a graph showing the characteristics of a hologram elements (for designed angle of incidence of 60°).

Further, consider as another example of hologram elements 26 the case having a designed angle of incidence of 60°, and being a photo polymer having a refractive index difference triangle symbol n of 0.05 The film thickness is 1 μm. As shown in FIG. 19, the properties of such hologram elements 26 are that while the peak diffraction efficiency in relation to S polarized light is low, the range of angles of incidence in which diffraction occurs is broad. Accordingly, these hologram elements 26 are suitable to be used for generating light beams of a poorly collimated angle as a light source 25, in which a bright image display is necessary.

The above simply provide examples of what the hologram elements 26 could be. By changing the settings as appropriate to determine the angle of incidence of incident light, the refractive index difference Δ n of the hologram material and the film thickness d for example, it is possible to produce a hologram elements 26 having the appropriate properties for the desired objective with respect to the diffraction efficiency and angle dependence for P polarized light and S polarized light

### Fourth Embodiment of the Illuminating Device According to the Present Invention

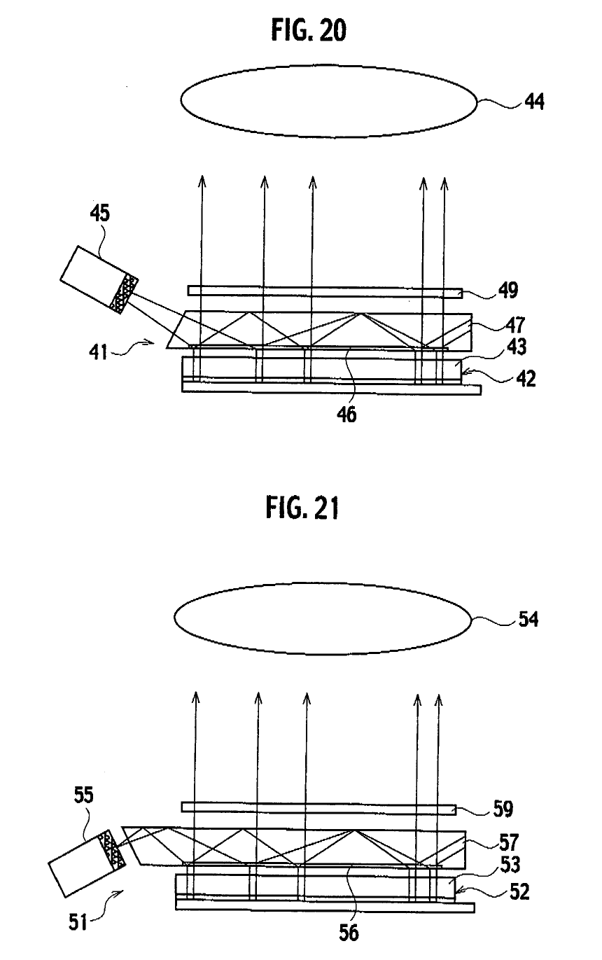

FIG. 20 is a cross sectional view showing the configuration of the display device providing the illuminating device according to the fourth embodiment related to the present invention.

As shown in FIG. 20, when this illuminating device related to the present invention uses for example an LED that emits light beams of a low parallel angle as the light source 45, it is preferable to employ as the hologram elements 46, elements designed having low entry angle dependence even though the diffraction efficiency is low.

In this case, light entering the side surface part of the plane parallel plate 47 from the light source 45 enters the hologram elements 46 and a part of that light is diffracted, and reflected to the reflective type liquid crystal display elements 42. The light that is not diffracted at the hologram elements 46 is totally reflected when the surface (rear surface) of the hologram elements 46 are in contact with the atmosphere. The light that is totally reflected in this way travels through the plane parallel plate 47 and again undergoes total reflection via the front surface part of this plate 47 before entering the hologram 46 where it is diffracted.

In this way, in the case of this illumination device light that is not diffracted at the hologram elements 46 is reused for lighting thereby enabling an improvement in the efficiency of light usage.

### Fifth Embodiment of the Illuminating Device According to the Present Invention

FIG. 21 is a cross-sectional view showing the configuration of a display device providing the illuminating device according to the fifth embodiment related to the present invention.

Further, as shown in FIG. 21, this illuminating device related to the present invention can be configured such that light entering the side surface part of the plane parallel plate 57 from the light source 55 irradiates the front surface part of the plane parallel plate 57 and undergoes total reflection at this front surface.

In this case, light from the light source 55 that enters the plane parallel plate 57 undergoes total reflection at the front surface part of the plane parallel plate 57 and thereafter, enters the hologram elements 56, where a part of this light is diffracted and enters the reflective type liquid crystal display device 52, That light which is not diffracted at the hologram elements 56 undergoes total reflection when the surface of these hologram elements 56 are in contact with the atmosphere. The light that undergoes total reflection in this way proceeds through the plane parallel plate 57 and again undergoes total reflection in the front surface part of this plane parallel plate 57, before entering the hologram elements 56 where it is diffracted.

In this way, in the case of this illuminating device, the efficiency with which the light is used can be improved by reusing light that is not diffracted at the hologram elements 56 and provides increased freedom in the positioning of the light source 55.

### Embodiment as a Projector

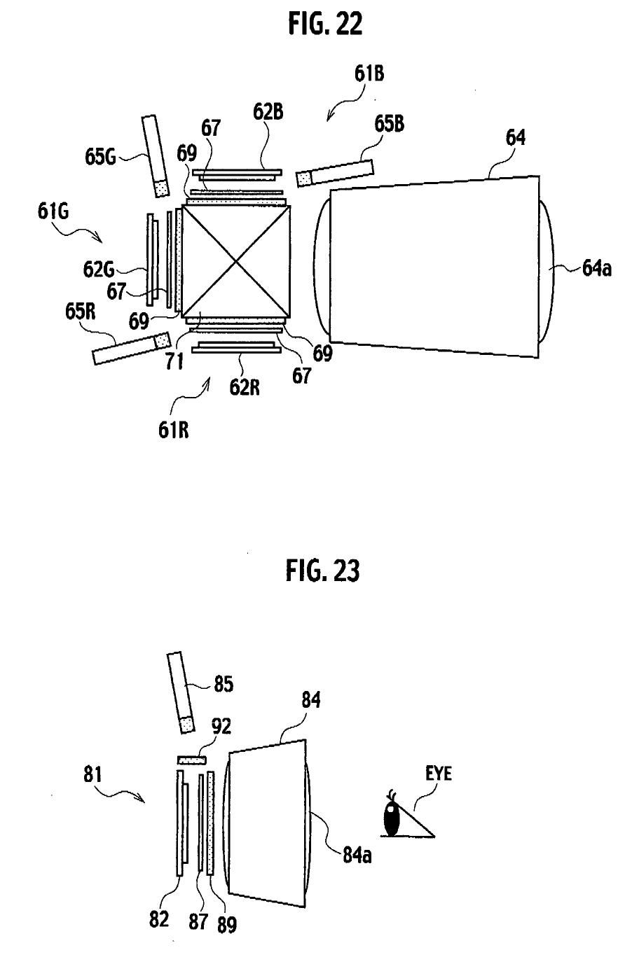

FIG. 22 is a cross sectional view showing the configuration of a display device relating to the present invention configured as a projection type display device (projector).

As shown in FIG. 22, when this display device is configured as a projection type display device (projector) capable of providing color display, three illuminating devices 61 R, 61 G and 61 B are used, that emit respectively one each of three primary colors by having a light source 65 R that emits R (red) light, a light source 65 G that emits G (green) light and a light source 65 B that emits B (blue) light, and these illuminating devices 61 R, 61 G and 61 B are disposed in correspondence with the reflective type liquid crystal display devices 62 R, 62 G and 62 B. It is suitable to use a three primary color laser array for example to provide these light sources 65 R, 65 G and 65 B.

The light of these colors via each of the reflective type liquid crystal display devices 62 R, 62 G and 62 B travels via a plane parallel plate 66 and polarizing plate 69, is input from the three directions comprising both side surfaces and the rear surface of a cross dichroic prism 61 and undergoes color composition in this cross dichroic prism 61 before being emitted from the front surface. The polarizing plate 69 is disposed so as to pass the light of a polarization direction orthogonal to the polarization direction of the linear polarized light emitted from the laser array.

Light emitted from this cross dichroic prism 61 is injected into a projection lens 64a that is an optical imaging system 64. This projection lens 64a provides an image display by forming the incoming light into an image on a image display surface not shown in the drawing

This display device can be provided in a configuration that is of small size and moreover can perform high brightness, high contrast and high-definition image display.

### Embodiment as an Electronic Viewfinder

FIG. 23 is a cross sectional view showing the configuration of a display device related to the present invention configured as an electronic viewfinder (EVF).

As shown in FIG. 23, when this display device is configured as an electronic viewfinder (EVF) that performs color display a illuminating device 81 is used that has a light source 85 that emits light of the three primary colors (R (red), G (green) and B (blue)), and the reflective type liquid crystal display device 82 is arranged in coordination with this illuminating device 81.

An LED array having a configuration in which LED of the three primary colors are arranged such that a plurality of these are alternately disposed can be used to provide the light source 85 that emits light of the three primary colors. The light emitted from this LED array passes a beam forming lens (not shown in the drawing), then travels via a polarizing plate 92 and enters a plane parallel plate 87. This plane parallel plate 87 and reflective type liquid crystal display elements 82 are disposed not tightly adjacent but arranged having a determined layer of atmosphere interposed therebetween.

Light (modulated light) of each of these colors that passes the reflective type liquid crystal display device 82, passes the plane parallel plate 87 and the polarizing plate 89 and is injected into an Lupe 84a. The polarizing plate 89 is disposed so as to pass linearly polarized light of a direction orthogonal to the direction of polarization of linearly polarized light that is passed by the polarizing plate 92 of the illuminating device. Further, the Lupe 84a performs image display by forming a virtual image of the input light.

In this display device image display is performed by the field sequential system as the three primary colors of the LED array light on and off sequentially. When displaying a monochrome image a white LED can be used as the light source.

LED used as light sources emit light beams that are not polarized light and moreover have a poor parallel aspect, thus providing low light use efficiency. However, where the purpose is direct observation of an expanded image (virtual image) expanded by an Lupe as in the case of an electronic viewfinder, this can provide sufficient light brightness for image display.

For such an electronic viewfinder a configuration that employs as the light source a laser light source with field sequencing can be used, while a projection lens may be used to provide the optical imaging system aching for enabling this to be used as a protector

What is claimed is:

1. A illuminating device used for illumination of a reflective type liquid crystal display device, comprising:
a light source part that is arranged in a lateral position in relation to the image display surface of the reflective type liquid crystal display device, that emits linear polarized light in a direction substantially parallel to the image display surface; and
a plurality of reflecting members, arranged in front of the image display surface of the reflective type liquid crystal display device and separated from the image display surface, that reflect the light emitted from the light source part and inject that light substantially vertically in relation to the image display surface,
wherein the plurality of reflective members are arranged to the front of part of the region of the image display surface of the reflective type liquid crystal display device and at least part of the light injected into the image display surface that is reflected by the image display surface is emitted toward the forward side of the image display surface.

2. The illuminating device according to claim 1, wherein the plurality of reflecting members are arranged in front of not more than half of the region of the image display surface of the reflective type liquid crystal display device.

3. The illuminating device according to claim 1, the plurality of reflective members are such that the ratio of the pitch of the reflective members to the width of that part that the reflected light from the reflective members cannot pass is not greater than 0.07.

4. The illuminating device according to claim 1, wherein the plurality of reflecting members are arranged inside a transparent, plane parallel plate arranged parallel to the image display surface and in front of the image display surface of the reflective type liquid crystal display device.

5. The illuminating device according to claim 1, wherein the plurality of reflecting members are the side wall faces of either groove parts or concave parts formed in the front part of a transparent, plane parallel plate arranged parallel to the image display surface and in front of the image display surface of the reflective type liquid crystal display device.

6. The illuminating device according to claim 1, wherein the plurality of reflecting members are arranged above the rear part of a transparent, plane parallel plate arranged parallel to the image display surface and in front of the image display surface of the reflective type liquid crystal display device.

7. The illuminating device according to claim 1, wherein the plurality of reflecting members are the side wall faces of either convex parts or concave parts formed in the front part of a transparent, plane parallel plate arranged parallel to the image display surface and in front of the image display surface of the reflective type liquid crystal display device.

8. The illuminating device according to claim 1, wherein a light absorbing member is disposed in the part surrounding the reflecting member.

9. A displaying device comprising:
the illuminating device according to claim 1;
a reflective type liquid crystal display device illuminated by that illuminating device; and
an optical imaging system into which light reflected from the reflective type liquid crystal display device is injected, that forms either an actual or a virtual image of the image display surface of a reflective type liquid crystal display device,
wherein the optical imaging system operates such that when the image display surface of the reflective type liquid crystal display device accommodates a determined focal depth, the plurality of reflecting members are outside that focal depth.

10. A illuminating device that utilizes illumination of a reflective type liquid crystal display device, comprising:
a light source arranged in a lateral position in relation to the image display surface of a reflective type liquid crystal display device, that emits light that is substantially parallel to the image display surface; and
bologram elements disposed in front of the image display surface of the reflective type liquid crystal display device and separated from the image display surface, that diffracts at least a part of the light emitted from the light source, and injects this diffracted light into the image display surface at an angle within a determined range centered around a direction perpendicular to the image display surface,
wherein light is injected into the image display surface of the reflective type liquid crystal display device and modulated light modulated and reflected by this reflective type liquid crystal display device passes the hologram elements and is emitted to the frontal side of the image display surface.

11. The illuminating device according to claim 10, wherein the hologram elements only diffract those light elements among the light emitted from the light source that are of a determined polarization, and do not exert any diffraction effect on incoming light of a polarization orthogonal to that determined polarization.

12. The illuminating device according to claim 10, wherein the hologram elements focus, or scatter and diffract light from the light source.

13. A display device comprising:
the illuminating device according to the claim 10;
a reflective type liquid crystal display device illuminated by that illuminating device; and
an optical imaging system into which modulated light reflected from the reflective type liquid crystal display device is injected, that forms either an actual or a virtual image of the image display surface of a reflective type liquid crystal display device,
wherein the angle of light input from hologram elements to the image display surface of the reflective type liquid crystal display device which angle is within a determined range centered around a direction perpendicular to the image display surface, is the angle obtained as the light, after being reflected by the reflective type liquid crystal display device, is input to the optical imaging system.
